(19) United States
(12) Patent Application Publication
(10) Pub. No.: US 2015/0378155 A1
(43) Pub. Date: Dec. 31, 2015

(54) METHOD FOR OPERATING VIRTUAL REALITY GLASSES AND SYSTEM WITH VIRTUAL REALITY GLASSES

(71) Applicant: AUDI AG, Ingolstadt (DE)

(72) Inventors: Marcus KUEHNE, Beilngries (DE); Thomas ZUCHTRIEGEL, Munich (DE)

(73) Assignee: AUDI AG, Ingolstadt (DE)

(21) Appl. No.: 14/751,553

(22) Filed: Jun. 26, 2015

(30) Foreign Application Priority Data
Jun. 26, 2014 (DE) 10 2014 009 701.3

(51) Int. Cl. G02B 27/01; G06T 19/00

(52) U.S. Cl. CPC G02B 27/017; G06T 19/006; G02B 2027/014

(57) ABSTRACT

A method for operating virtual reality glasses involves displaying at least one virtual object by the virtual reality glasses from a virtual viewing position and continuously detecting a position of the virtual reality glasses and adjusting a virtual spacing between the virtual viewing position and the virtual object. Once the virtual viewing position passes through a surface bounding an element of the object from the outside, the representation of the element is altered. Furthermore, a system with virtual reality glasses may be used.

### CROSS REFERENCE TO RELATED APPLICATIONS

This application is based on and hereby claims priority to German Application No. 10 2014 009 701.3 filed on Jun. 26, 2014, the contents of which are hereby incorporated by reference.

### BACKGROUND

The invention relates to a method for operating virtual reality glasses and a system with virtual reality glasses.

Virtual reality glasses are a certain form of a so-called head-mounted display, being a visual output device that is worn on the head. It presents images on a display screen close to the eyes or projects them directly onto the retina. Virtual reality glasses even also have sensors for detecting movement of the head. This allows the display of the computed illustration to be adjusted to a movement of the wearer of the glasses. As a result of the physical proximity, the displayed image areas of the head-mounted display appear considerably larger than the free-standing display screens and in the extreme case even cover the entire field of view of the user. Because the display follows all head movements of the wearer as a result of the head mounting, he has the feeling of moving directly in a computer-generated image landscape.

Using such virtual reality glasses, a virtual reality can thus be displayed, wherein the display and simultaneous perception of the reality in its physical properties in an interactive virtual environment that is computer-generated in real time is usually referred to as a virtual reality.

Because both the orientation and also the positioning of the virtual reality glasses can usually be detected by a sensor system belonging to the virtual reality glasses, a virtual viewing position from which a virtual object is displayed by the virtual reality glasses can be mapped within the virtual environment in an substantially one-to-one manner.

The result of this is that, for example in the case of virtual product presentations by virtual reality glasses, a wearer of such glasses can view a virtual object in a very natural way. This means that by moving the head closer, for example in a virtual vehicle cockpit, even details in the virtual interior can be viewed in more detail. In doing so it can occur that the user, when approaching corresponding elements of the virtual object, moves up to them too closely and effectively passes into the elements concerned, which is especially undesirable in a product presentation.

Previous known ways of responding to this are relatively limited. From the computer games field in connection with virtual reality glasses it is known that the previously described penetration is prevented by the user virtually remaining hanging at the relevant element of the object or virtually bouncing off it. However, this can result in the user feeling queasy, because he is suddenly decelerated within the virtual environment, whereby a conflict occurs between the visual impression and the lack of motion feedback of the vestibular system in the inner ear.

### SUMMARY

One possible object is to provide a method for operating virtual reality glasses and a system with virtual reality glasses, by which the problem described above of immersion in a virtual object can be prevented in an improved way.

The inventors propose a method for operating virtual reality glasses. According to the method, at least one virtual object is displayed by the virtual reality glasses from a virtual viewing position. In doing so a position of the virtual reality glasses is continuously detected and a virtual spacing between the virtual viewing position and the virtual object is adjusted. Once the virtual viewing position passes through a surface bounding an element of the object from the outside, the representation of the relevant element will be changed.

It is thus provided according to the proposals that once it is detected that a user of the virtual reality glasses passes into the displayed virtual object within the displayed virtual environment, at least the relevant sub-region of the object into which it passes is shown altered. In contrast to the solution mentioned above in connection with computer games, the user of the virtual reality glasses in the case of virtually passing into a virtual object is thus no longer abruptly decelerated in the virtual environment. Instead of this, by the altered representation of the relevant sub-region of the object into which he has just virtually passed it is simply indicated to the user that he has just carried out a physically meaningless movement in an inner cross section of an element of the virtual object in the virtual environment. He has thus virtually passed into the object through a surface externally bounding the object. As a result of the altered representation of the relevant element, the user usually makes a corresponding head movement as a reflex in order to move his virtual viewing position back out of the object.

In an advantageous embodiment, it is provided that the sharpness with which the element is displayed is reduced in order to alter the representation. Preferably, the resolution with which the element is displayed is reduced here. For this purpose for example, the resolution of the respective display of the virtual reality glasses can be reduced such that at least the element in which the user of the virtual reality glasses is currently virtually immersed is displayed with a reduced resolution. Alternatively or in addition, it is also possible that the contrast with which the element is displayed is reduced. The difference between light and dark regions of the relevant element is thus reduced as a result, i.e. the brightness profile of the displayed element is altered. Because the intensity difference between lighter and darker regions of the element is reduced, it is also made clear to the user of the virtual reality glasses in a simple way that he is currently virtually immersed in the relevant element.

In another advantageous embodiment, it is provided that the color with which the element is displayed is altered in order to alter the representation. For example, the element can be displayed with a particularly bright color, using which the element and the rest of the object would not usually be displayed in a natural representation. Therefore a visual indication is given to the user of the virtual reality glasses in a simple way that he is currently virtually immersed in the relevant element of the object.

A further advantageous embodiment provides that in order to alter the representation the surface bounding the element of the object is faded out and a region within the element, especially in the form of a wire grid structure, is displayed. As a result the user of the virtual reality glasses is shown that he is currently virtually immersed in an inner cross section of the relevant element of the object, i.e. his virtual viewing point has moved into a cross section located within the element. The relevant element of the object is thus virtually cut open, which is preferably shown by a wire grid type of representation of the inner region of the element.

According to another advantageous embodiment, it is provided that the element is hidden in order to alter the representation. In doing this the element can be suddenly removed once the virtual viewing position has been moved into the relevant element. Alternatively, it is also possible that the element is only successively slowly faded out over a specified period of time. The removal of the element visually indicates to the user of the virtual reality glasses that he has just carried out a movement in the displayed virtual object that is not physically meaningful in reality.

According to a further advantageous embodiment, it is provided that the degree of alteration of the representation is increased with increasing penetration depth of the virtual viewing position within the element and is reduced with reducing penetration depth of the virtual viewing position within the element. For example, the virtual reality glasses can be activated such that the sharpness with which the element is displayed is reduced ever more markedly the deeper the virtual viewing position penetrates within the interior of the element and vice-versa. Alternatively or in addition, it can also be provided that a color profile is specified from the realistic representation prior to penetration of the element up to a particularly bright color, wherein the relevant element is shown increasingly brightly with increasing penetration depth within the element and vice-versa. Alternatively or in addition, it can also be provided that the degree of fading out of the element is increased with increasing penetration depth within the element and vice-versa. For example, the element is shown as ever more transparent with increasing penetration depth and vice-versa. The user of the virtual reality glasses thus gets particularly good feedback relating to the effects of his head movement and of the degree of penetration within the relevant element of the virtual object. As a result he can adjust his head movements particularly simply or can control them such that he easily virtually exits from the element.

In a further advantageous embodiment, it is provided that, once the virtual viewing position has passed through the surface bounding the element from the outside, the rest of the object is additionally altered in its representation. As a result the visual indication character is increased further, because not only is the relevant element in which the user is currently virtually immersed shown altered, but also the rest of the object is shown altered. The degree of alteration in relation to this element can be selected here to be greater than the degree of alteration of the rest of the object, so that the user can detect as well as previously into which region of the virtual object he has just passed in a physically meaningless manner. The alteration of the representation of the rest of the object can take place in this case in the same way as already described in relation to the element.

A further advantageous embodiment provides that the alteration of the representation of the element and/or of the rest of the object is reversed once the virtual viewing position passes through the surface bounding the element from the inside. In other words, the alteration of the representation of the element and/or of the rest of the object is thus reversed once the user of the virtual reality glasses has positioned and moved his head such that he has moved back out of the element and thus out of the virtual object. Thus once the user of the virtual reality glasses has altered his head position such that the virtual viewing position is no longer within the relevant element and is thus also no longer within the object, the element and/or the entire object is again displayed in its natural manner of representation.

In a further advantageous embodiment, it is provided that a motor vehicle is displayed as the virtual object. For example, as a result the number of versions of motor vehicles with different equipment to be retained can be considerably reduced for car dealerships. A potential buyer can simply put the virtual reality glasses on and virtually and particularly realistically view the motor vehicle that he has just configured from diverse perspectives.

The inventors also propose a system having virtual reality glasses that are designed to display a virtual object from a virtual viewing position. The system further comprises a detecting device that is designed to continuously detect a position of the virtual reality glasses. Furthermore, the system comprises a control device that is designed to activate the virtual reality glasses such that a virtual spacing between the virtual viewing position and the virtual object is adjusted depending on the position of the virtual reality glasses. Furthermore, the control device is designed to activate the virtual reality glasses such that a representation of the element is altered once the virtual viewing position passes through a surface bounding an element of the object from the outside. Advantageous embodiments of the proposed method are to be considered to be advantageous embodiments of the proposed system, wherein the system especially comprises mechanisms for carrying out the the method.

Further advantages, features and details are revealed in the following description of preferred exemplary embodiments and using the figures. The features and combinations of features mentioned above in the description and the features and combinations of features mentioned below in the description of the figures and/or shown in the figures alone are not only able to be used in the respective specified combination, but also in other combinations or on their own without departing from the scope.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a schematic representation of a system with virtual reality glasses for representation of virtual reality content;

FIG. 2 shows a front view of a user that is wearing the virtual reality glasses;

FIG. 3 shows a side view of the user while he is wearing the virtual reality glasses;

FIG. 4 shows a motor vehicle displayed by the virtual reality glasses, wherein the motor vehicle is being displayed from a first viewing position;

FIG. 5 shows a schematic front view of the virtual motor vehicle, by which the virtual viewing position is indicated; and

FIG. 6 shows a schematic top view of the virtual motor vehicle, by which the virtual viewing position is also indicated.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

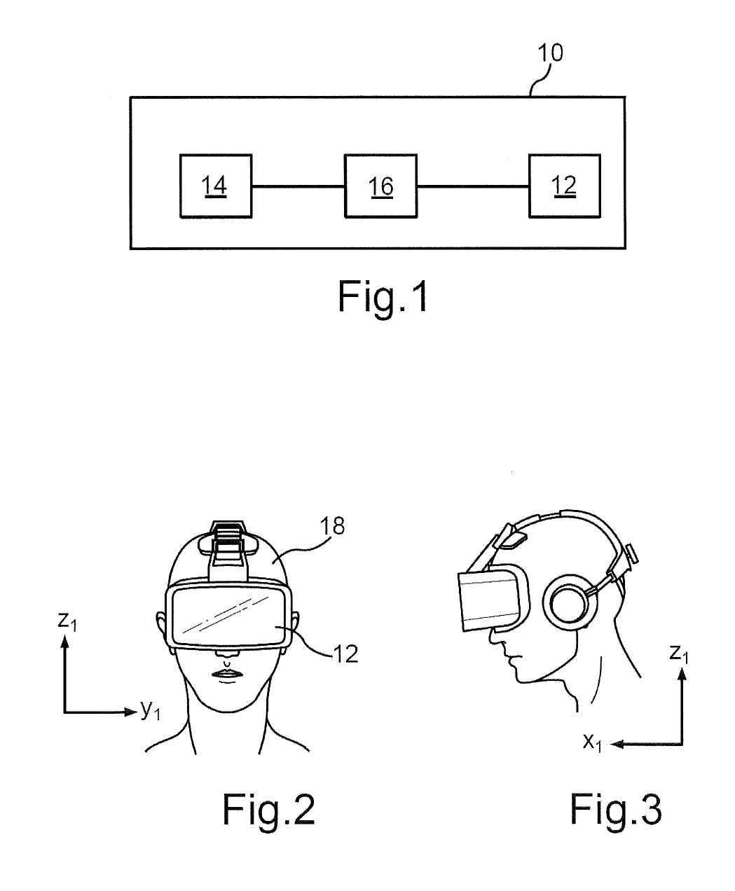

A system 10, referred to as a whole with 10, for displaying virtual reality content is shown in a schematic representation in FIG. 1. The system 10 comprises virtual reality glasses 12 that are designed to display a virtual object from a virtual viewing position. In the present case the virtual reality glasses 12 are especially designed to display a virtual motor vehicle, which is not shown here, from diverse virtual positions.

The system 10 comprises, moreover, a detecting device 14 that is designed to continuously detect a position of the virtual reality glasses 12. The detecting device 14 can for example comprise sensor elements that are disposed on the virtual reality glasses 12 and additionally on elements different from the virtual reality glasses 12. For example, the detecting device 12 can comprise an infrared-based sensing system, by which the position of the virtual reality glasses 12 and the change of the position of the virtual reality glasses 12 can be detected.

In addition, the system comprises a control device 16 that is designed to activate the virtual reality glasses 12 such that a virtual spacing that is not shown here between the virtual viewing position of a user wearing the virtual reality glasses 12 and the virtual object displayed by the virtual reality glasses 12 is adjusted depending on the respective continuously detected position of the virtual reality glasses 12. Furthermore, the control device 16 is designed to activate the virtual reality glasses 12 such that a representation of the element is altered once the virtual viewing position passes through a surface bounding an element of the object from the outside.

A user 18 that is wearing the virtual reality glasses 12 is shown in FIG. 2. In the present case the user 18 is shown in a front view. In FIG. 3 the user 18 together with the virtual reality glasses 12 is shown in a side view. By the coordinate axes x¹, y¹ and z¹ a coordinate system is described, within which the position and orientation of the virtual reality glasses 12 can be detected by the detecting device 14.

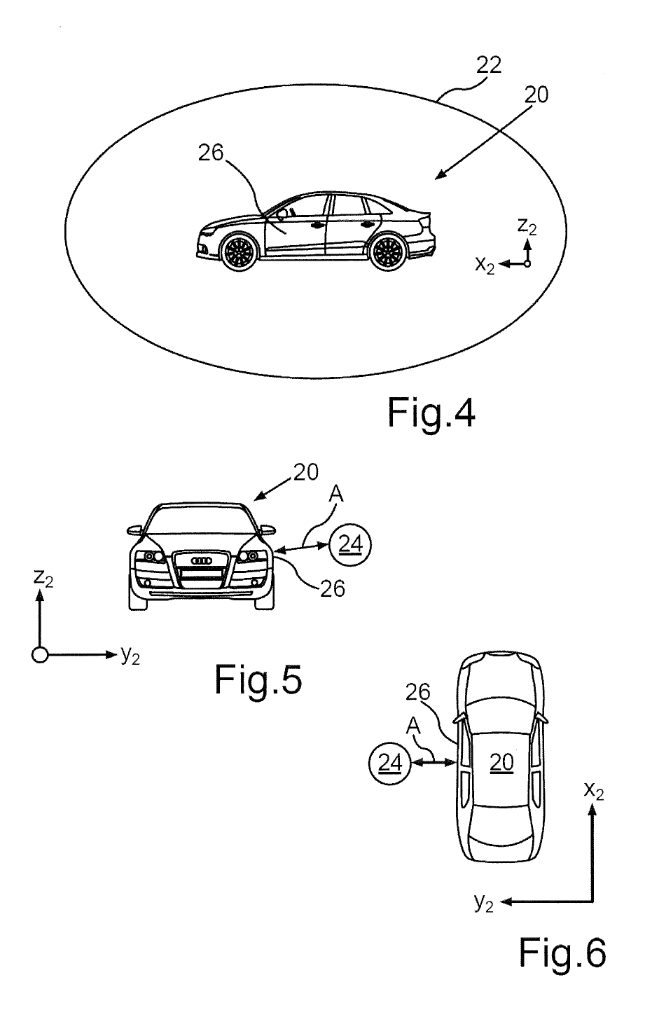

In FIG. 4 a virtual motor vehicle 20 displayed by the virtual reality glasses 12 is illustrated. In this case the user 18 can move within a virtual environment 22 around the virtually displayed motor vehicle 20 and can also sit in the motor vehicle 20. In the present case the motor vehicle 20 is displayed from a virtual viewing position 24 as schematically illustrated in FIGS. 5 and 6 if the user 18 has oriented his head straight as shown in FIGS. 2 and 3. In the present case the user 18 has thus tilted his head neither to the left nor to the right and neither up nor down.

As schematically illustrated in FIG. 5, the virtual viewing position 24 is thus laterally adjacent to the virtual motor vehicle 20, so that the user 18 is looking sideways at the virtual motor vehicle 20. The virtual viewing position 24 can again easily be seen in FIG. 6 in a schematic top view of the virtual motor vehicle 20.

Using the detecting device 14, the position of the virtual reality glasses 12 is continuously detected in relation to the coordinate system formed by the coordinate axes x¹, x² and z¹. In doing so both translational movements and also rotational movements of the virtual reality glasses 12 are detected.

As long as the user 18 only causes pivoting of the virtual reality glasses 12 by his head movements, the virtual viewing position 24 does not change relative to the virtual motor vehicle 20. In other words, the motor vehicle 20 is thus always displayed from the unchanged virtual viewing position 24. Only the viewing angle of the virtual motor vehicle 20, starting from the unchanged virtual viewing position 24, is changed.

However, if the user 18 bends forwards for example, i.e. in the direction x₁, then the position of the virtual reality glasses 12 changes translationally. The virtual viewing position 24 also changes translationally within the virtual environment 22 according to the detected translational position change of the virtual reality glasses 12. In other words, an adjustment of a virtual spacing A between the virtual viewing position 24 and the virtual motor vehicle 20 thus takes place. The virtual viewing position 24 can be understood here to correspond to the virtual position of the head of the user 18 within the virtual environment 22.

If the user 18 were to really bend forward or move forwards in the direction x₁ so far that the corresponding translational displacement of the virtual viewing position 24 takes place such that the spacing A between the virtual viewing position 24 and the left vehicle door 26 of the virtual motor vehicle 20 is reduced to zero, then the user 18 is disposed with his head directly on the vehicle door 26 within the virtual environment 22.

If the user 18 now moves his head further in the direction x₁, then he passes into the vehicle door 26, because the virtual viewing position 24 is also shifted into the vehicle door 26. Once the virtual viewing position 24 passes through the surface of the vehicle door 26 the representation of the vehicle door is altered in order to make the user 18 aware that he has just carried out a movement within the virtual environment 22 that is physically impossible in reality.

For example, the sharpness with which the vehicle door 26 is displayed can be reduced. Preferably, this is achieved by reducing the resolution with which the vehicle door 26 is displayed. Alternatively or in addition, it can also be provided that the contrast with which the vehicle door 26 is displayed is also reduced. Moreover, it is additionally or alternatively also possible that the color with which the vehicle door 26 is displayed is altered. Alternatively, it is also possible that the vehicle door 26 is faded out once the user 18 has passed through the surface of the vehicle door 26 within the virtual environment 22, i.e. has effectively virtually moved within the cross section of the vehicle door 26.

Furthermore, it can be provided that a virtual cutting open of the region of the vehicle door 26 in which the user 18 is virtually immersed is displayed as a visual effect. The currently virtually penetrated surface of the vehicle door 26 is thus no longer displayed. In this case the relevant inner cross section of the vehicle door 26 is displayed in the form of a wire grid model or a wire grid structure, as is known for example from CAD figures. At the same time the wire grid structure, by which the inner cross section of the vehicle door 26 is identified, is additionally displayed with a particularly distinctive color, e.g. with a red color.

In this case the degree of alteration of the representation can be increased with increasing penetration depth of the virtual viewing position 24, i.e. the virtual head position of the user 18, within the vehicle door 26 and is in turn reduced with decreasing penetration depth of the virtual viewing position 24, and thus the virtual head position, within the vehicle door 26. Once the user 18 has moved his head or himself such that the position change of the virtual reality glasses 12 has caused a corresponding alteration of the virtual viewing position 24 out of the vehicle door 26, the vehicle door 26 is again displayed completely normally, so that the user 18 can easily detect that he is virtually no longer in the interior or in the cross section of the vehicle door 26.

Besides the change of the representation of the vehicle door 26 alone, it is also possible that once the user 18 has virtually entered the vehicle door 26 the rest of the motor vehicle 20 will also be displayed differently in order to give the user 18 an additional visual indication that he has just carried out a movement within the virtual environment 22 that is physically meaningless in the real world. The change of the representation of the rest of the motor vehicle 20 can take place here in a similar manner to that for the vehicle door 26.

Whenever the user 18 changes the position of the virtual reality glasses 12 by his movements so that the virtual viewing position 24 passes into an element of the motor vehicle 20, i.e. passes through a surface bounding the volume of an element of the motor vehicle 20, at least the relevant element is displayed altered. For example, if the user 18 is virtually located on the driver's seat, i.e. within the motor vehicle 20, and bends his head forward slightly, in order for example to view the steering wheel of the virtual motor vehicle 20 more closely, the representation of the steering wheel would be altered once the user 18 virtually enters the steering wheel. Similarly, all other elements of the motor vehicle 20 are displayed altered if the user 18 passes into the relevant elements by suitable positioning of the virtual reality glasses 12. Using the method described the user 18 is thus made aware in a simple manner that he should change his head position and thus the position of the virtual reality glasses 12 in order to cause a realistic representation of the motor vehicle 20 to be displayed again.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1. A method for operating virtual reality glasses, the method comprising:
displaying a virtual object in a virtual environment using the virtual reality glasses for viewing the virtual object from a virtual viewing position in the virtual environment;
continuously detecting a position of the virtual reality glasses and adjusting a virtual spacing between the virtual viewing position and the virtual object; and
when the virtual viewing position passes from outside the virtual object through a surface bounding an element of the virtual object, altering a display representation of the element.

2. The method according to claim 1, wherein
altering the display representation comprises reducing a sharpness with which the element is displayed.

3. The method according to claim 2, wherein
altering the display representation further comprises reducing a resolution with which the element is displayed.

4. The method according to claim 2, wherein
altering the display representation further comprises reducing a contrast with which the element is displayed.

5. The method according to claim 1, wherein
altering the display representation comprises altering a color with which the element is displayed.

6. The method according to claim 1, wherein
altering the display representation comprises fading out the surface bounding the element of the virtual object and displaying an internal region of the element so that the virtual viewing position is immersed inside the element of the virtual object.

7. The method according to claim 6, wherein
the internal region includes a wire grid structure.

8. The method according to claim 1, wherein
altering the display representation comprises fading out the element.

9. The method according to claim 1, wherein altering the display representation comprises:
increasing a degree of alteration of the display representation with increasing penetration depth of the virtual viewing position within the element, and
reducing the degree of alteration of the display representation with decreasing penetration depth of the virtual viewing position within the element.

10. The method according to claim 1, wherein
when the virtual viewing position passes from outside the virtual object through the surface bounding the element, altering a display representation of another portion of the virtual object.

11. The method according to claim 1, further comprising:
reversing the alteration of the display representation of the element when the virtual viewing position passes from inside the virtual object to outside the virtual object through the surface bounding the element.

12. The method according to claim 10, further comprising:
reversing the alteration of the display representation of the another portion of the virtual object when the virtual viewing position passes from inside the virtual object to outside the virtual object through the surface bounding the element.

13. The method according to claim 1, wherein
a motor vehicle is displayed as the virtual object.

14. The method according to claim 1, wherein:
rotational movement of the virtual reality glasses changes a viewing angle of the virtual object without changing the virtual spacing between the virtual viewing position and the virtual object, and
translational movement of the virtual reality glasses changes the virtual spacing between the virtual viewing position and the virtual object without changing the viewing angle of the virtual object.

15. A virtual reality system, comprising:
virtual reality glasses to display a virtual object in a virtual environment from a virtual viewing position in the virtual environment;
a detecting device to continuously detect a position of the virtual reality glasses; and
a control device to adjust a virtual spacing between the virtual viewing position and the virtual object depending on the position of the virtual reality glasses, and when the virtual viewing position passes from outside the virtual object through a surface bounding an element of the virtual object, to alter a display representation of the element.

16. The virtual reality system according to claim 15, wherein
the detecting device comprises an infrared-based sensing element.

17. The virtual reality system according to claim 15, wherein
the virtual object is a vehicle, and the element is a first part of the vehicle, and
when the virtual viewing position passes from outside the virtual object through a surface of the first part, a display representation of at least one of the first part and another part of the vehicle other than the first part is altered to provide an indication to a user wearing the virtual reality glasses that the user is currently virtually immersed inside the first part.

18. The virtual reality system according to claim 17, wherein
the display representation of the first part is altered by at least one of reducing a sharpness with which the first part is displayed, reducing a resolution with which the first part is displayed, reducing a contrast with which the first part is displayed, altering a color with which the first part is displayed, and fading out the first part.

19. The virtual reality system according to claim 17, wherein
the display representation of the first part is altered by displaying an inner cross section of the first part in the form of a wire grid model or a wire grid structure and changing a color of the first part.

20. The virtual reality system according to claim 18, wherein
a display representation of the another part is altered by at least one of reducing a sharpness with which the another part is displayed, reducing a resolution with which the another part is displayed, reducing a contrast with which the another part is displayed, altering a color with which the another part is displayed, and fading out the another part.

21. A method for operating virtual reality glasses worn by a user, the method comprising:
displaying a virtual object in a virtual environment using the virtual reality glasses worn by the user for viewing the virtual object from a virtual viewing position in the virtual environment;
detecting rotational and translational movements of the virtual reality glasses worn by the user by sensing head movements of the user;
changing a virtual spacing between the virtual viewing position and the virtual object based on the translational movements of the virtual reality glasses worn by the user;
determining whether the virtual spacing between the virtual viewing position and the virtual object changes such that the virtual viewing position passes from outside the virtual object through a surface bounding an element of the virtual object; and
when the virtual viewing position passes from outside the virtual object through the surface bounding the element of the virtual object, altering a display representation of the element of the virtual object to indicate to the user a real-world physically meaningless movement.
